(19) United States
(12) Patent Application Publication
(10) Pub. No.: US 2018/0364778 A1
(43) Pub. Date: Dec. 20, 2018

(54) ARTIFICIAL INTELLIGENCE TYPE ELECTRIC OUTLET HAVING AUTOMATIC STANDBY POWER CUT-OFF AND RESTORATION FUNCTION

(71) Applicant: WELLBAS LIMITED, Ansan-si, Gyeonggi-do (KR)

(72) Inventor: Keun jin LEE, Goyang-si, Gyeonggi-do (KR)

(73) Assignee: WELLBAS LIMITED, Ansan-si, Gyeonggi-do (KR)

(21) Appl. No.: 16/061,673

(22) PCT Filed: Jan. 13, 2017
(86) PCT No.: PCT/KR2017/000440

§ 371 Date: Jun. 13, 2018

(30) Foreign Application Priority Data
Jan. 28, 2016 (KR) 10-2016-0010729
Oct. 25, 2016 (KR) 10-2016-0138933

(51) Int. Cl. G06F 1/26; G06F 1/32; G06F 3/041; H01H 13/14; H01R 25/00; H01R 13/717; H01R 13/713

(52) U.S. Cl. CPC G06F 1/266; G06F 1/3287; G06F 3/0416; G06F 2200/261; H01R 25/003; H01R 13/7175; H01R 13/713; H01H 13/14

(57) ABSTRACT

The present invention relates to an artificial intelligence type electric outlet having an automatic standby power cut-off and restoration function and, more specifically, to an artificial intelligence type electric outlet: enabling automatic standby power cut-off and restoration by applying a technique of an object detection sensor, which is a combination of a PIR sensor and an IR sensor; applying, by a manual method, a touch switch having a touch IC applied thereto, a TACT switch, and an IR wireless reception sensor and applying, by an automatic method, an object detection sensor and a human body detection sensor for sensing a distance and an object, such that the manual method and the automatic method can be selectively used by means of a function switch of an electric outlet; and sharply classifying a normal electric outlet and an electric outlet having a power-saving function by mounting and applying, to the electric outlet, an three-stage AC rocker switch, which saves power by connecting the exiting normal electric outlet with a power-saving function integrated in a computer and can regulate the power entering the electric outlet, through a complete separation from and connection to a power-saving circuit using the bipolar cut-off so as to implement continuous, power-saving, and cut-off functions, thereby providing convenience and practicality to the electric outlet.

### TECHNICAL FIELD

The present invention relates to an artificial intelligence type electric outlet having automatic standby power cut-off and recovery functions, which enables the automatic cut-off and recovery of standby power by applying the technology of an object detection sensor, which is a combination of a PIR sensor and an IR sensor, which applies a touch switch employing a touch IC, a tact switch, and an IR wireless reception sensor in a manual method and applies a human body detection sensor and an object detection sensor for sensing a distance and an object in an automatic method, such that the manual method and the automatic method can be selectively used by means of a function switch of the electric outlet, which can be implemented and operated by inserting a functional element into an electric outlet casing while maintain the external appearance of a design thereof without the need of forming a hole thereon by inserting a function switch 11 as a touch tact switch and an LED 12 into an injection-molded product without having the touch tact switch 11 and the LED 12 protrudingly formed on a top surface thereof, which can convert and control four functions of powering on, continuous power supplying, standby power setting, and overload cutoff releasing depending on the time when and the frequency which the function switch of the electric outlet, configured as a single button is pressed, and can represent a specific function while simultaneously changing a function of the electric outlet using an LED indication and sounds identified by the naked eyes and the buzzer, which has mounted thereon an three-stage AC rocker switch, which can save power by allowing the conventional common electric outlet to be operated in association with a power-saving function incorporated in a computer and can control functions of continuously supplying, saving, and cutting off the power entering the electric outlet through a complete separation from and connection to a power-saving circuit using the bipolar cut-off, thereby providing convenience and practicality to the electric outlet by strictly dividing a common electric outlet and an electric outlet having a power-saving function, which has an external receiver connecting port formed at one side of the AC three-stage rocker switch so that the amount of electric current of the device plugged into the main power receptacle can be grasped through the external receiver connecting port upon the connection of an automatic and manual switch thereto so as to interrupt or recover the main power receptacle, which can function to transmit the amount of electric current (and electric power) to a control center or other organization using the wired or wireless reception unit through a wired and wireless communication method by grasping the standby power and consumed power of the device plugged into the electric outlet through an current IC and a shunt resistor, and receive an instruction to control the four functions of powering on, continuous power supplying, standby power setting, and overload cutoff releasing through a computer or a smartphone in which the Internet is implemented so that the Internet of Things (IoT) communication control method based on bidirectional communication control can be applied to the control of the electric outlet.

### BACKGROUND ART

An electrical product commonly used in homes, offices, or industrial facilities such as factories is classified into two categories: one is a product that is required to be constantly electrically connected to a power source to receive electric power from the power source like a refrigerator, and the other is a product that is required to be supplied with electrical energy only during a specific period of time when a person does an activity like a TV set, an audio system, or a computer monitor.

However, even in the case of the latter electrical product, because a power source is electrically connected to an electric outlet or receptacle mounted on a wall surface or a floor, the electrical product is mostly used in a state of being connected to a normal power source due to the difficulty and inconvenience of interrupting electric power.

FIG. 1 is a view showing a configuration of an electric power supply system that supplies electric power to an electrical product 200 according to the prior art. A plug of an electrical product is connected to an AC power source or a common electric outlet 100 to supply electrical energy. In addition, the electrical product is mostly used in a state of being connected to a normal power source due to the difficulty and inconvenience of interrupting electric power.

Thus, a lot of unnecessary power is consumed due to leakage power, which involves the risk of a big fire due to electric leakage. The conversion cost in terms of the nationwide waste power caused by such leakage power results in considerable power waste.

Further, although an electrical/electronic product that is connected to an electric outlet are powered off, a small amount of current flows through the products, resulting in small power consumption. Such a small amount of power flowing through the products is called quiescent or standby power. Such standby power has an adverse effect on the lifespan of the electronic product as well as is a part of power waste. In addition, there is a problem in that accidents are highly likely to occur by electrical leakage current.

Accordingly, such standby power is required to be cut off, in which case a user suffers from an inconvenience of having to one-by-one locate electrical/electronic products that respectively consume standby power and separate the located electrical/electronic products from the electric outlet. In this case, when it is difficult to separate the located electrical/electronic products due to the user's inconvenience and inadvertence, there is caused a problem in that the standby power cannot be interrupted.

Moreover, the technologies relating to domestic and overseas power saving electric outlet products lead to a decrease in the utilization of the power saving electric outlet due to an inconvenience in the use of a method for recovering electric power with a wired and wireless communication and a manual switch after the automatic standby power cutoff.

In addition, one of methods for maximally saving and efficiently using electric power, i.e., an ice thermal energy storage method mainly used as a thermal energy storage method using midnight electricity entails problems in that it increases an initial investment ratio, an installation space, and a thermal energy storage tank space due to additional installation of various devices including a thermal energy storage tank, makes it impossible to utilize an existing facility when applied to a conventional building, and increases the maintenance and repair cost due to an increase in the number of additionally installed devices.

Besides, as disclosed in Korean Patent Registration Publication (Korean Patent No. 10-0773869: Oct. 31, 2007), a multi-socket outlet is conventionally designed to enable a communication with a personal computer, and a power interruption switch of the multi-socket outlet is driven by the personal computer or by using a separate remote controller to control the supply of electric power to an electronic product or a timer is installed in series with a power switch of the multi-socket outlet so that the timer can arbitrarily set the time when power is supplied to the electronic product.

However, in the case where it is desired to reduce a standby power loss of the electronic product by driving the power interruption switch of the multi-socket outlet, a personal computer or a separate remote controller is required to be provided. In addition, the use of the electronic product may not be permitted except the time set arbitrarily

Therefore, there is an urgent need for the development of an artificial intelligence type electric outlet having automatic standby power cut-off and recovery functions, which enables the automatic cut-off and recovery of standby power by applying the technology of an object detection sensor, which is a combination of a PIR sensor and an IR sensor, which can be implemented and operated by inserting a functional element into an electric outlet casing while maintain the external appearance of a design thereof without the need of forming a hole thereon by inserting a function switch 11 as a touch tact switch and an LED 12 into an injection-molded product without having the touch tact switch 11 and the LED 12 protrudingly formed on a top surface thereof, which can convert and control four functions of powering on, continuous power supplying, standby power setting, and overload cutoff releasing depending on the time when and the frequency which the function switch of the electric outlet, configured as a single button is pressed, and can represent a specific function while simultaneously changing a function of the electric outlet using an LED indication and sounds identified by the naked eyes and the buzzer, which has mounted thereon an three-stage AC rocker switch, which can save power by allowing the conventional common electric outlet to be operated in association with a power-saving function incorporated in a computer and can control functions of continuously supplying, saving, and cutting off the power entering the electric outlet through a complete separation from and connection to a power-saving circuit using the bipolar cut-off, thereby providing convenience and practicality to the electric outlet by strictly dividing a common electric outlet and an electric outlet having a power-saving function, and which can function to transmit the amount of electric current (and electric power) to a control center or other organization using the wired or wireless reception unit through a wired and wireless communication method, and receive an instruction to control the four functions of powering on, continuous power supplying, standby power setting, and overload cutoff releasing through a computer or a smartphone in which the Internet is implemented so that the Internet of Things (IoT) communication control method based on bidirectional communication control can be applied to the control of the electric outlet.

### DISCLOSURE OF INVENTION

### Technical Problem

Accordingly, the present invention has been made in order to solve the above-described problems occurring in the prior art, and it is an object of the present invention to provide an artificial intelligence type electric outlet having automatic standby power cut-off and recovery functions, which enables the automatic cut-off and recovery of standby power by applying the technology of an object detection sensor, which is a combination of a PIR sensor and an IR sensor.

Another object of the present invention is to provide an artificial intelligence type electric outlet having automatic standby power cut-off and recovery functions, which applies a touch switch employing a touch IC, a tact switch, and an IR wireless reception sensor in a manual method and applies a human body detection sensor and an object detection sensor for sensing a distance and an object in an automatic method, such that the manual method and the automatic method can be selectively used by means of a function switch of the electric outlet.

Still another object of the present invention is to provide an artificial intelligence type electric outlet having automatic standby power cut-off and recovery functions, which can be implemented and operated by inserting a functional element into an electric outlet casing while maintain the external appearance of a design thereof without the need of forming a hole thereon by inserting a function switch 11 as a touch tact switch and an LED 12 into an injection-molded product without having the touch tact switch 11 and the LED 12 protrudingly formed on a top surface thereof.

Yet another object of the present invention is to provide an artificial intelligence type electric outlet having automatic standby power cut-off and recovery functions, which can convert and control four functions of powering on, continuous power supplying, standby power setting, and overload cutoff releasing depending on the time when and the frequency which the function switch of the electric outlet, configured as a single button is pressed, and can represent a specific function while simultaneously changing a function of the electric outlet using an LED indication and sounds identified by the naked eyes and the buzzer.

A further object of the present invention is to provide an artificial intelligence type electric outlet having automatic standby power cut-off and recovery functions, which has mounted thereon an three-stage AC rocker switch, which can save power by allowing the conventional common electric outlet to be operated in association with a power-saving function incorporated in a computer and can control functions of continuously supplying, saving, and cutting off the power entering the electric outlet through a complete separation from and connection to a power-saving circuit using the bipolar cut-off, thereby providing convenience and practicality to the electric outlet by strictly dividing a common electric outlet and an electric outlet having a power-saving function.

A still further object of the present invention is to provide an artificial intelligence type electric outlet having automatic standby power cut-off and recovery functions, which has an external receiver connecting port formed at one side of the AC three-stage rocker switch so that the amount of electric current of the device plugged into the main power receptacle can be grasped through the external receiver connecting port upon the connection of an automatic and manual switch thereto so as to interrupt or recover the main power receptacle.

A yet further object of the present invention is to provide an artificial intelligence type electric outlet having automatic standby power cut-off and recovery functions, which can function to transmit the amount of electric current (and electric power) to a control center or other organization using the wired or wireless reception unit through a wired and wireless communication method by grasping the standby power and consumed power of the device plugged into the electric outlet through an current IC and a shunt resistor, and receive an instruction to control the four functions of powering on, continuous power supplying, standby power setting, and overload cutoff releasing through a computer or a smartphone in which the Internet is implemented so that the Internet of Things (IoT) communication control method based on bidirectional communication control can be applied to the control of the electric outlet.

### TECHNICAL SOLUTION

To achieve the above objects, in accordance with a preferred embodiment of the present invention, there is provided an artificial intelligence type electric outlet having automatic standby power cut-off and recovery functions, which includes: an electric outlet casing including a power receptacle unit having a continuous power receptacle for functioning as a common electric outlet that allows electric plugs of various electronic devices to be plugged thereinto in use, a main power receptacle for dividedly setting the amount of electric current of an electronic device plugged into the main power receptacle to grasp an in-use state, a power-saving state, and a power-off state of the electronic device, and turning ON/OFF an auxiliary power receptacle based on a reference value, and one or more auxiliary power receptacles that is operated in response to a control signal from the main power receptacle, or having the continuous power receptacle and the main power receptacle, the electric outlet casing being configured to maintain the external appearance of a design thereof without the need of forming a hole thereon by inserting a function switch as a touch tact switch and an LED into an injection-molded product without having the touch tact switch and the LED protrudingly formed on a top surface thereof; and an electric outlet driving module protectively mounted in the electric outlet casing, the electric outlet driving module functioning to implement automatic standby power cut-off and recovery by applying the technology of an object detection sensor, which is a combination of a PIR sensor and an IR sensor, functioning to convert and control four functions of powering on, continuous power supplying, standby power setting, and overload cutoff releasing through the function switch of the electric outlet, and functioning to transmit the amount of electric current (and electric power) to a control center or other organization using the wired or wireless reception unit through a wired and wireless communication method and receive an instruction to control the four functions of powering on, continuous power supplying, standby power setting, and overload cutoff releasing through a computer or a smartphone in which the Internet is implemented.

In the present invention, the electric outlet driving module may include: a power source unit that serves as an SMAP power supply circuit and enable stable circuit operation by converting AC into DC, the power source unit being configured to generate and output an operating voltage to be supplied to respective internal elements of the electric outlet from a power source; an operation condition setting unit for setting whether or not to use the object detection sensor, a human body detection sensor, and the touch tact switch, whether or not to output light from the LED, and a cooperative operation condition or a single operation condition of an electrical home appliance based on a user's switching operation, and outputting a switching signal according to the setting operation; a wireless transmission and reception unit for interconnecting an object detection sensor for sensing a distance and an object and a human body detection sensor using a computer or a smartphone via a wired and wireless communication network so as to determine whether or not the object detection sensor and the human body detection sensor detect the object and the human body; a built-in human body detection sensor and a touch operation condition setting unit for sensing a person's touch change or motion to output signals corresponding to four functions of powering on, continuous power supplying, standby power setting, and overload cutoff releasing according to the sensed result; a current detection unit for detecting electric current flowing through the electrical home appliance that is operated under the cooperative operation condition or the single operation condition and outputting a detection signal according to the detection result; a controller for receiving the detection signal and the user's switching signal for selection of a cooperative operation function or a single operation function, outputting an ON or OFF control signal for integratedly controlling a buzzer, a relay, a PIR sensor, a mode switch, an overload breaker, an IR sensor, and an LED, and semipermanently storing a function control value and a standby power value; and an output control unit for receiving the ON or OFF control signal from the controller and controlling the supply or interruption of electric current entering and flowing through a power-saving receptacle of the electric outlet using a relay.

In the present invention, the artificial intelligence type electric outlet may further include an three-stage AC rocker switch formed in the electric outlet casing for controlling functions of continuously supplying, saving, and cutting off the power entering the electric outlet through a complete separation from and connection to a power-saving circuit using the bipolar cut-off.

In the present invention, the artificial intelligence type electric outlet having automatic standby power cut-off and recovery functions may further include: an external receiver connecting port formed at one side of the AC three-stage rocker switch and configured to allow the amount of electric current of the device plugged into the main power receptacle to be grasped therethrough upon the connection of an automatic and manual switch thereto so as to interrupt or recover the main power receptacle; and a recovery and setting button unit formed at one side of the AC three-stage rocker switch and configured to selectively convert both recovery and setting functions with one button.

In the present invention, the artificial intelligence type electric outlet may further include an overload breaker configured to cut off overload when the electric outlet to which the electric plug is connected is overloaded.

In the present invention, the function switch as the touch tact switch may include a function of restoring the operating state of the power-saving receptacle to an electrical conductive state again after the supply of the power to the power-saving receptacle is interrupted when the switch button is pressed once, a function of restoring the operating state of the power-saving receptacle to the power-saving state after the supply of the power to the power-saving receptacle is interrupted automatically within 10 seconds during the supply of electric current ranging from 16A to 19A to the power-saving receptacle when the switch button is pressed twice, a function of releasing the function of a power-saving electric outlet to cause the power-saving receptacle to be converted into a common continuous power receptacle when the button is pressed and released continuously three times within 3 seconds, and a function of storing a current value of the standby power of the device plugged into the power-saving receptacle in a memory of the controller (MCI) through a current IC and an amplification IC within 20 seconds when the button is pressed long for 5 seconds or less, at which time the LED blinds on and off rapidly so that the storage state can be identified with naked eyes and through sounds generated from a buzzer. In a method for representing a function indication of the LED 12, the blinking on and off of a green LED once for 1 second may be an indication meaning that the electric outlet is in a standby power state and the power is cut off within 3 minutes, the continuous turning on of the green LED may be an indication meaning that the device plugged into the electric outlet is in use, the continuous turning on of a red LED, followed by the turning off of the red LED at a preset time may be an indication meaning that the function of the electric outlet is converted from a power-saving function to a common electric outlet function, and the turning off of the LEDs may be an indication meaning that the device plugged into the power-saving receptacle is in a powered-off state.

In the present invention, the electric outlet driving module may function to transmit the amount of electric current (and electric power) to a control center or other organization using the wired or wireless reception unit through a wired and wireless communication method by grasping the standby power and consumed power of the device plugged into the electric outlet through an current IC and a shunt resistor, and receive an instruction to control the four functions of powering on, continuous power supplying, standby power setting, and overload cutoff releasing through a computer or a smartphone in which the Internet is implemented.

In the present invention, the artificial intelligence type electric outlet having automatic standby power cut-off and recovery functions may apply a touch switch employing a touch IC, a tact switch, and an IR wireless reception sensor in a manual method, and may apply a human body detection sensor and an object detection sensor for sensing a distance and an object in an automatic method, such that the manual method and the automatic method can be selectively used as an electric power recovery method by means of the function switch.

In the present invention, the artificial intelligence type electric outlet having automatic standby power cut-off and recovery functions may set and input the powering on- and off-time of the electric outlet using an application of a smartphone or a personal computer through a radio communication selected from Bluetooth, Zigbee communication, RF communication, and then act as a timer automatically.

In the present invention, the artificial intelligence type electric outlet having automatic standby power cut-off and recovery functions may be selectively applied from a floor-buried electric outlet, a wall-buried electric outlet, a mobile multi-socket outlet, and a power strip.

### Advantageous Effects

As described above, the artificial intelligence type electric outlet having automatic standby power cut-off and recovery functions according to the present invention has the following effects.

First, the artificial intelligence type electric outlet having automatic standby power cut-off and recovery functions of the present invention enables the automatic cut-off and recovery of standby power by applying the technology of an object detection sensor as a combination of a PIR sensor and an IR sensor.

Second, the artificial intelligence type electric outlet having automatic standby power cut-off and recovery functions of the present invention applies a touch switch employing a touch IC, a tact switch, and an IR wireless reception sensor in a manual method, and applies a human body detection sensor and an object detection sensor for sensing a distance and an object in an automatic method, such that the manual method and the automatic method can be selectively used as an electric power recovery method by means of the function switch of the electric outlet.

Third, the artificial intelligence type electric outlet having automatic standby power cut-off and recovery functions of the present invention can be implemented and operated by inserting a functional element into an electric outlet casing while maintain the external appearance of a design thereof without the need of forming a hole thereon by inserting a function switch 11 as a touch tact switch and an LED 12 into an injection-molded product without having the touch tact switch 11 and the LED 12 protrudingly formed on a top surface thereof.

Fourth, the artificial intelligence type electric outlet having automatic standby power cut-off and recovery functions of the present invention can convert and control four functions of powering on, continuous power supplying, standby power setting, and overload cutoff releasing depending on the time when and the frequency which the function switch of the electric outlet, configured as a single button is pressed, and can represent a specific function while simultaneously changing a function of the electric outlet using an LED indication and sounds identified by the naked eyes and the buzzer.

Fifth, the artificial intelligence type electric outlet having automatic standby power cut-off and recovery functions of the present invention has mounted thereon an three-stage AC rocker switch, which can save power by allowing the conventional common electric outlet to be operated in association with a power-saving function incorporated in a computer and can control functions of continuously supplying, saving, and cutting off the power entering the electric outlet through a complete separation from and connection to a power-saving circuit using the bipolar cut-off, thereby providing convenience and practicality to the electric outlet by strictly dividing a common electric outlet and an electric outlet having a power-saving function.

Sixth, the artificial intelligence type electric outlet having automatic standby power cut-off and recovery functions of the present invention has an external receiver connecting port formed at one side of the AC three-stage rocker switch so that the amount of electric current of the device plugged into the main power receptacle can be grasped through the external receiver connecting port upon the connection of an automatic and manual switch thereto so as to interrupt or recover the main power receptacle.

Seventh, the artificial intelligence type electric outlet having automatic standby power cut-off and recovery functions of the present invention can function to transmit the amount of electric current (and electric power) to a control center or other organization using the wired or wireless reception unit through a wired and wireless communication method by grasping the standby power and consumed power of the device plugged into the electric outlet through an current IC and a shunt resistor, and receive an instruction to control the four functions of powering on, continuous power supplying, standby power setting, and overload cutoff releasing through a computer or a smartphone in which the Internet is implemented so that the Internet of Things (IoT) communication control method based on bidirectional communication control can be applied to the control of the electric outlet.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view showing an electric power supply system of an electrical product according to the prior art;

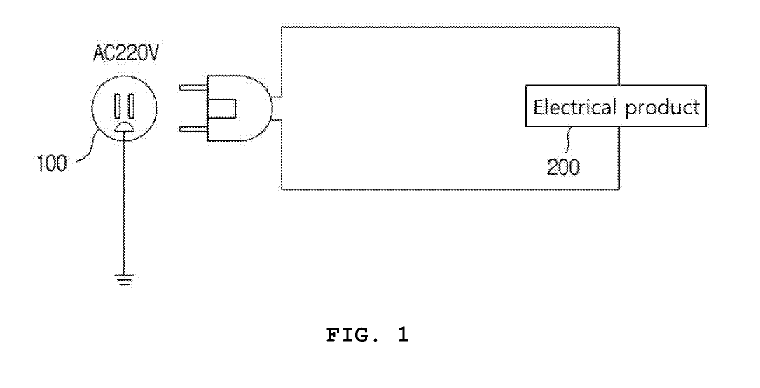

FIG. 2 is a view showing a configuration of an artificial intelligence type electric outlet having automatic standby power cut-off and recovery functions according to one embodiment of the present invention;

FIG. 3 is a view showing a configuration of a modification of an artificial intelligence type electric outlet having automatic standby power cut-off and recovery functions according to one embodiment of the present invention;

FIG. 4 is a configuration of a switch structure having a hole through which a spring of an internal injection-molded product passes so that the spring comes into close contact with an underside of an external injection-molded product to supply a touch signal current by means of the spring and a touch pad of a touch unit in an artificial intelligence type electric outlet according to one embodiment of the present invention;

FIG. 5 is a block diagram showing a module for driving an artificial intelligence type electric outlet having automatic standby power cut-off and recovery functions according to one embodiment of the present invention;

FIG. 6 is a view showing a configuration of an artificial intelligence type electric outlet having automatic standby power cut-off and recovery functions according to another embodiment of the present invention;

FIG. 7 is a view showing a state in which continuous power supply, power-saving, and power cut-off functions are controlled by power receptacles and an AC three-stage rocker switch of an artificial intelligence type electric outlet having automatic standby power cut-off and recovery functions according to another embodiment of the present invention;

FIG. 8 is a circuit diagram of an MCU circuit showing the integrated control of a buzzer, a relay, a PIR sensor, a mode switch, an overload breaker, an IR sensor, and an LED in a module for driving an artificial intelligence type electric outlet having automatic standby power cut-off and recovery functions according to another embodiment of the present invention;

FIG. 9 is a circuit diagram showing a touch switch that enables conversion of four functions of powering on, continuous power supplying, standby power setting, and overload cutoff releasing in a module for driving an artificial intelligence type electric outlet having automatic standby power cut-off and recovery functions according to another embodiment of the present invention; and

FIG. 10 is a circuit diagram showing an IR sensor and LED circuit for allowing the operations of the artificial intelligence type electric outlet according to one embodiment of the present invention to be distinguished with naked eyes.

### BEST MODE FOR CARRYING OUT THE INVENTION

Reference will be now made in detail to preferred embodiments of the present invention with reference to the attached drawings. In the following description, the detailed description on related known function and constructions unnecessarily obscuring the subject matter of the present invention will be avoided hereinafter. Also, the terms used herein are defined in consideration of the function of the present invention, which may vary according to an intention of a user or an operator or according to custom. Thus, the definition of such terms should be made based on the contents throughout the specification disclosing an artificial intelligence type electric outlet having automatic standby power cut-off and recovery functions according to the present invention.

Hereinafter, an artificial intelligence type electric outlet having automatic standby power cut-off and recovery functions according to preferred embodiments of the present invention will be described in detail with reference to the accompanying drawings.

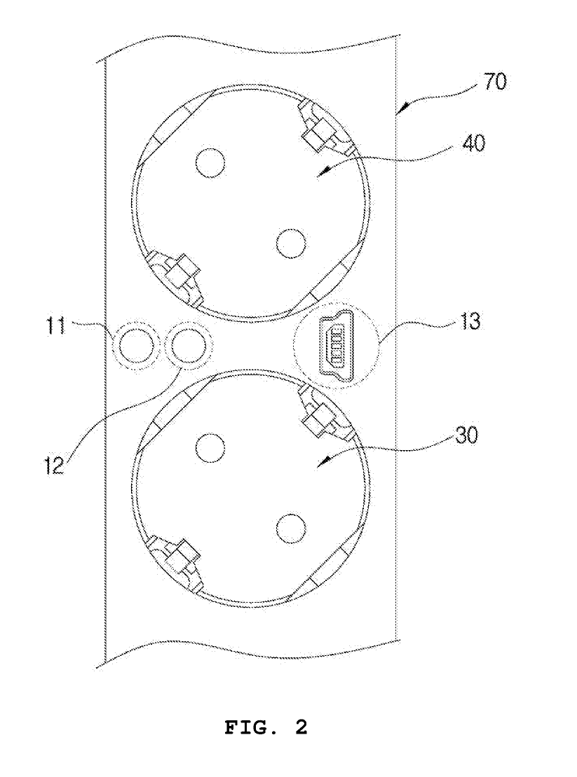

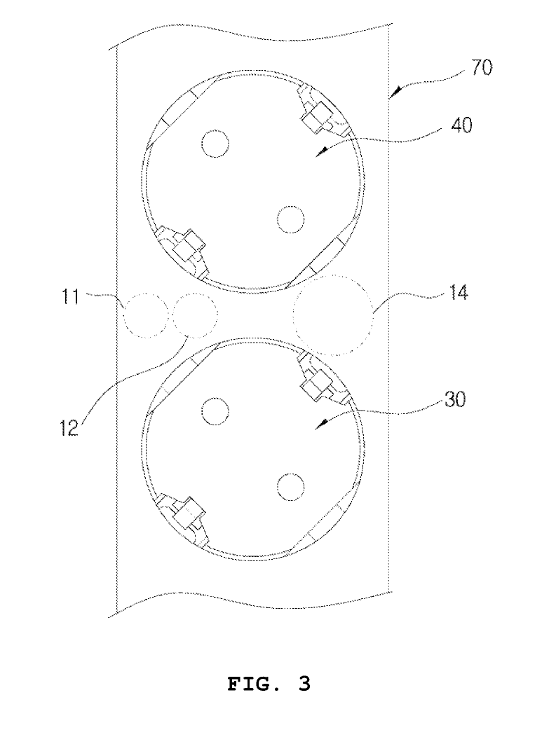

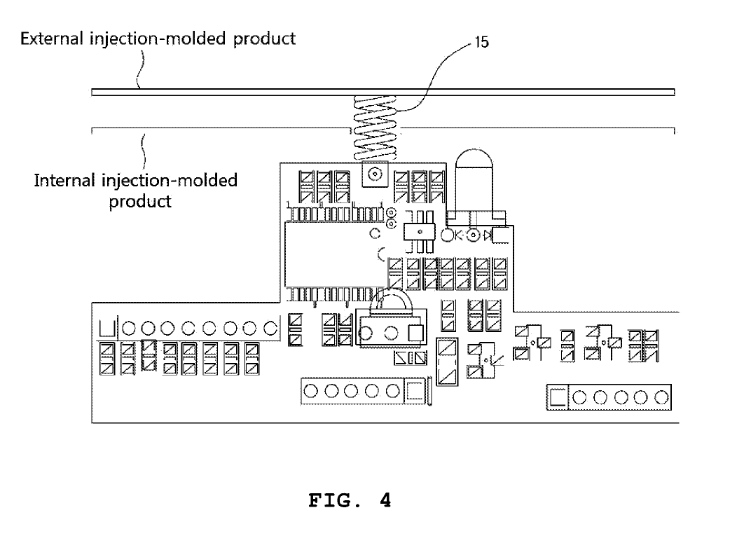

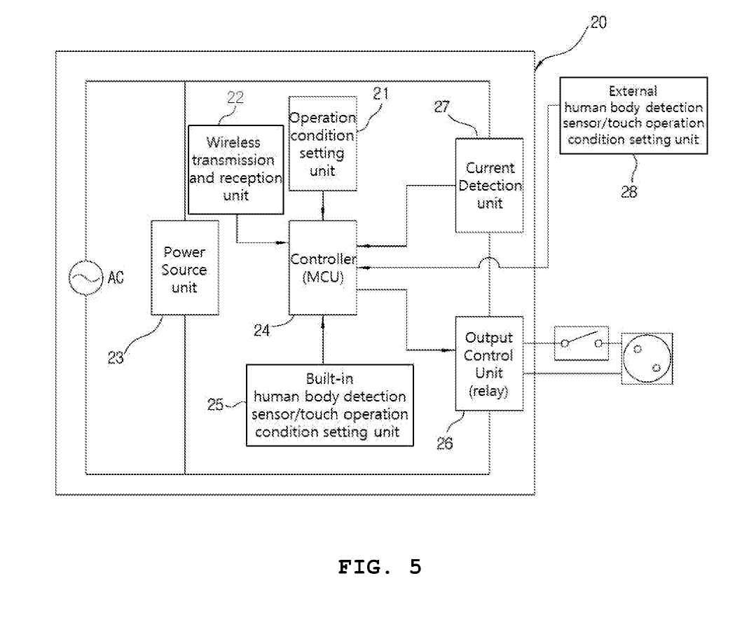

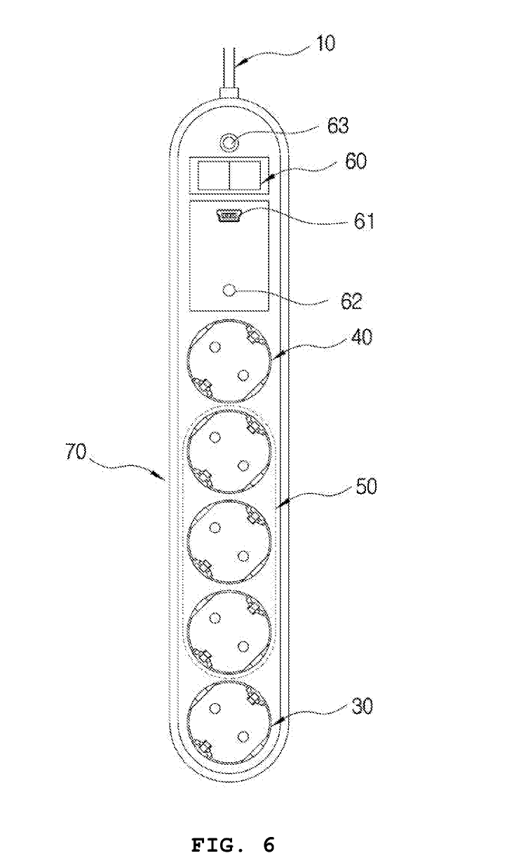

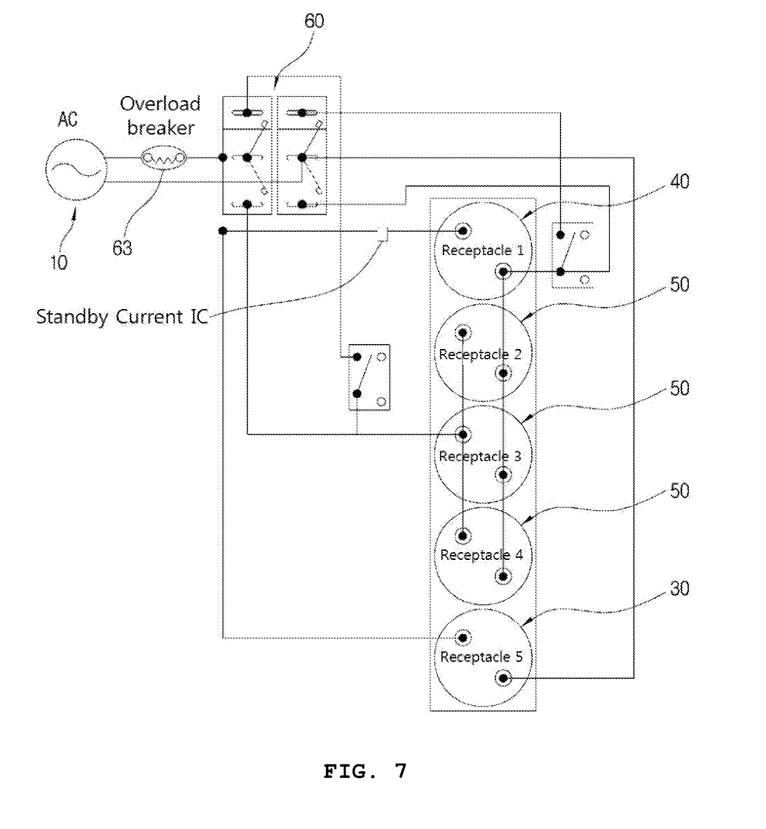

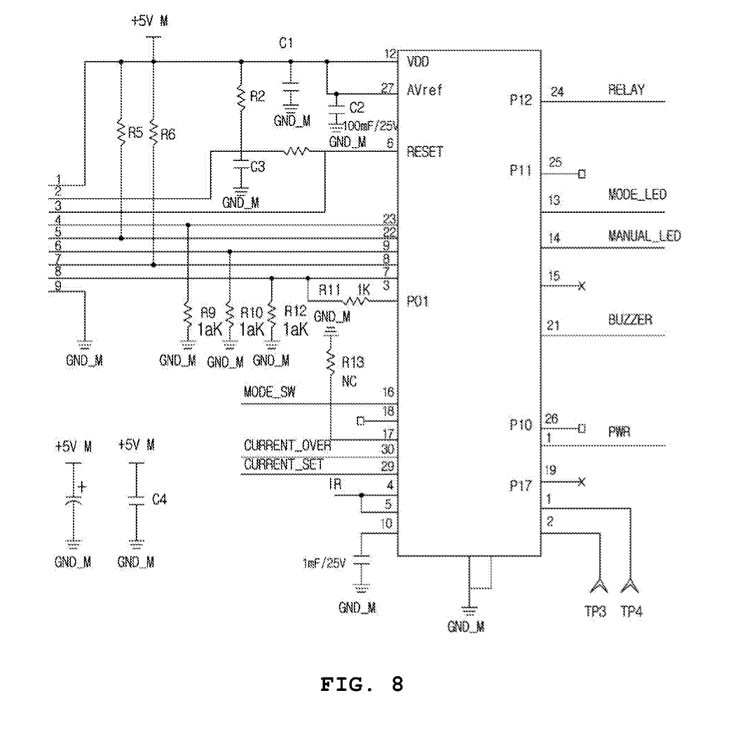

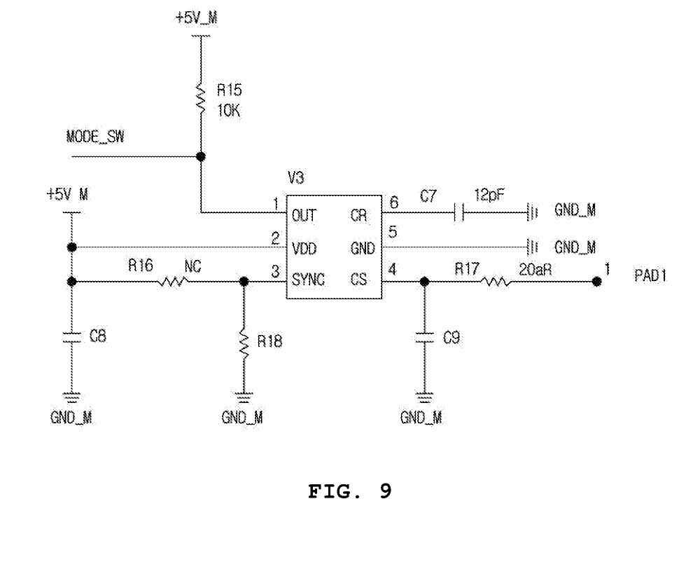

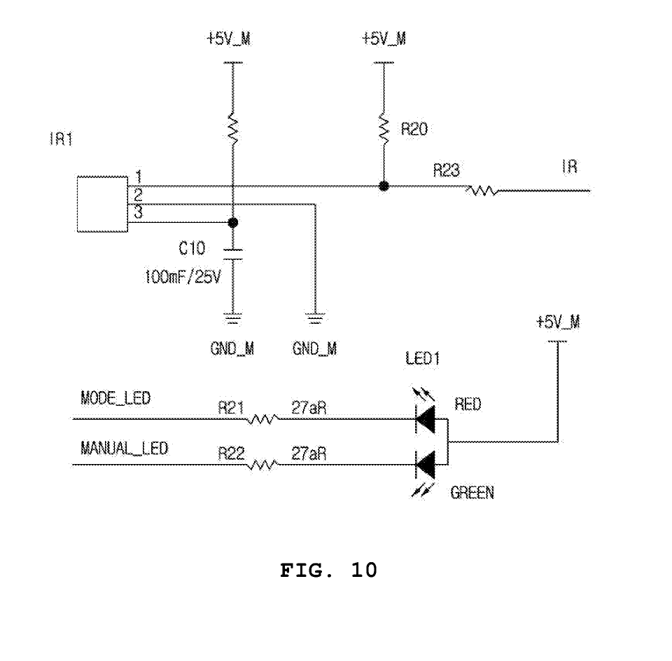

FIG. 2 is a view showing a configuration of an artificial intelligence type electric outlet having automatic standby power cut-off and recovery functions according to one embodiment of the present invention, FIG. 3 is a view showing a configuration of a modification of an artificial intelligence type electric outlet having automatic standby power cut-off and recovery functions according to one embodiment of the present invention, FIG. 4 is a configuration of a switch structure having a hole through which a spring of an internal injection-molded product passes so that the spring comes into close contact with an underside of an external injection-molded product to supply a touch signal current by means of the spring and a touch pad of a touch unit in an artificial intelligence type electric outlet according to one embodiment of the present invention, FIG. 5 is a block diagram showing a module for driving an artificial intelligence type electric outlet having automatic standby power cut-off and recovery functions according to one embodiment of the present invention, FIG. 6 is a view showing a configuration of an artificial intelligence type electric outlet having automatic standby power cut-off and recovery functions according to another embodiment of the present invention, FIG. 7 is a view showing a state in which continuous power supply, power-saving, and power cut-off functions are controlled by power receptacles and an AC three-stage rocker switch of an artificial intelligence type electric outlet having automatic standby power cut-off and recovery functions according to another embodiment of the present invention, FIG. 8 is a circuit diagram of an MCU circuit showing the integrated control a buzzer, a relay, a PIR sensor, a mode switch, an overload breaker, an IR sensor, and an LED in a module for driving an artificial intelligence type electric outlet having automatic standby power cut-off and recovery functions according to another embodiment of the present invention, FIG. 9 is a circuit diagram showing a touch switch that enables conversion of four functions of powering on, continuous power supplying, standby power setting, and overload cutoff releasing in a module for driving an artificial intelligence type electric outlet having automatic standby power cut-off and recovery functions according to another embodiment of the present invention, and FIG. 10 is a circuit diagram showing an IR sensor and LED circuit for allowing the operations of the artificial intelligence type electric outlet according to one embodiment of the present invention to be distinguished with naked eyes.

An artificial intelligence type electric outlet 70 having automatic standby power cut-off and recovery functions according to the present invention includes an electric outlet casing 10, a touch tact switch 11, an LED 12, a USB connector 13, an external wireless reception unit 14, a spring 15, an electric outlet driving module 20, an operation condition setting unit 21, a wireless transmission and reception unit 22, a power source unit 23, a controller (MCU) 24, a built-in human body detection sensor/a touch operation condition setting unit 25, an output control unit (relay) 26, a current detection unit 27, an external human body detection sensor/a touch operation condition setting unit 28, a continuous power receptacle 30, a main power receptacle 40, an auxiliary power receptacle 50, an AC three-stage rocker switch 60, an external receiver connecting port 61, a recovery and setting button unit 62, and an overload breaker 63.

As shown in FIGS. 2 to 10, the artificial intelligence type electric outlet 70 having automatic standby power cut-off and recovery functions according to one embodiment of the present invention includes: an electric outlet casing 10 including a power receptacle unit having a continuous power receptacle 30 for functioning as a common electric outlet that allows electric plugs of various electronic devices to be plugged thereinto in use, a main power receptacle 40 for dividedly setting the amount of electric current of an electronic device plugged into the main power receptacle 40 to grasp an in-use state, a power-saving state, and a power-off state of the electronic device, and turning ON/OFF an auxiliary power receptacle based on a reference value, and a plurality of auxiliary power receptacles 50 that is operated in response to a control signal from the main power receptacle 40, or having the continuous power receptacle 30 and the main power receptacle 40, the electric outlet casing being configured to maintain the external appearance of a design thereof without the need of forming a hole thereon by inserting a function switch 11 as a touch tact switch and an LED 12 into an injection-molded product without having the touch tact switch 11 and the LED 12 protrudingly formed on a top surface thereof; and an electric outlet driving module 20 protectively mounted in the electric outlet casing 10, the electric outlet driving module functioning to implement automatic standby power cut-off and recovery by applying the technology of an object detection sensor, which is a combination of a PIR sensor and an IR sensor, functioning to convert and control four functions of powering on, continuous power supplying, standby power setting, and overload cutoff releasing through the function switch 11 of the electric outlet, and functioning to transmit the amount of electric current (and electric power) to a control center or other organization using the wired or wireless reception unit 22 through a wired and wireless communication method and receive an instruction to control the four functions of powering on, continuous power supplying, standby power setting, and overload cutoff releasing through a computer or a smartphone in which the Internet is implemented. The artificial intelligence type electric outlet having automatic standby power cut-off and recovery functions further includes an external human body detection sensor and a touch operation condition setting unit 28, which are disposed separately from the electric outlet driving module 20, and sense a person's touch change or motion to output signals corresponding to four functions of powering on, continuous power supplying, standby power setting, and overload cutoff releasing according to the sensed result.

In addition, the artificial intelligence type electric outlet having automatic standby power cut-off and recovery functions according to one embodiment of the present invention further includes: an AC three-stage rocker switch 60 that is formed in the electric outlet casing and is configured to control functions of continuously supplying, saving, and cutting off the power entering the electric outlet through a complete separation from and connection to a power-saving circuit using the bipolar cut-off; an external receiver connecting port 61 formed at one side of the AC three-stage rocker switch and configured to allow the amount of electric current of the device plugged into the main power receptacle to be grasped therethrough upon the connection of an automatic and manual switch thereto so as to interrupt or recover the main power receptacle; a recovery and setting button unit 62 formed at one side of the AC three-stage rocker switch and configured to selectively convert both recovery and setting functions with one button; and an overload breaker 63 configured to cut off overload when the electric outlet to which the electric plug is connected is overloaded.

The functions of respective technical means constituting the artificial intelligence type electric outlet having automatic standby power cut-off and recovery functions will be described hereinafter.

As shown in FIGS. 2, 3 and 6 and 7, the electric outlet casing 10 includes a power receptacle unit having a continuous power receptacle 30 for functioning as a common electric outlet that allows electric plugs of various electronic devices to be plugged thereinto in use, a main power receptacle 40 for dividedly setting the amount of electric current of an electronic device plugged into the main power receptacle 40 to grasp an in-use state, a power-saving state, and a power-off state of the electronic device, and turning ON/OFF an auxiliary power receptacle based on a reference value, and a plurality of auxiliary power receptacles 50 that is operated in response to a control signal from the main power receptacle 40, or having the continuous power receptacle 30 and the main power receptacle 40. The electric outlet casing maintains the external appearance of a design thereof without the need of forming a hole thereon by inserting a function switch 11 as a touch tact switch and an LED 12 into an injection-molded product without having the touch tact switch 11 and the LED 12 protrudingly formed on a top surface thereof. In this case, the electric outlet casing 10 has the USB connector 13 and the external wireless reception unit 14, which are formed on the top surface thereof, besides the touch tact switch 11 and the LED 12.

In addition, as shown in FIG. 4, a switch structure has a hole through which a spring 15 of an internal injection-molded product passes so that the spring comes into close contact with an underside of an external injection-molded product to supply a touch signal current by means of the spring and a touch pad of a touch unit in an artificial intelligence type electric outlet according to one embodiment of the present invention.

The electric outlet driving module 20 is protectively mounted in the electric outlet casing 10. The electric outlet driving module functions to implement automatic standby power cut-off and recovery by applying the technology of an object detection sensor, which is a combination of a PIR sensor and an IR sensor, functions to convert and control four functions of powering on, continuous power supplying, standby power setting, and overload cutoff releasing through the function switch 11 of the electric outlet, and functions to transmit the amount of electric current (and electric power) to a control center or other organization using the wired or wireless reception unit 22 through a wired and wireless communication method and receive an instruction to control the four functions of powering on, continuous power supplying, standby power setting, and overload cutoff releasing through a computer or a smartphone in which the Internet is implemented.

As shown in FIG. 5, the electric outlet driving module 20 includes: a power source unit 23 that serves as an SMAP power supply circuit and enable stable circuit operation by converting AC into DC, the power source unit being configured to generate and output an operating voltage to be supplied to respective internal elements of the electric outlet from a power source; an operation condition setting unit 21 for setting whether or not to use the object detection sensor, a human body detection sensor, and the touch tact switch, whether or not to output light from the LED, and a cooperative operation condition or a single operation condition of an electrical home appliance based on a user's switching operation, and outputting a switching signal according to the setting operation; a wireless transmission and reception unit 22 for interconnecting an object detection sensor for sensing a distance and an object and a human body detection sensor using a computer or a smartphone via a wired and wireless communication network so as to determine whether or not the object detection sensor and the human body detection sensor detect the object and the human body; a built-in human body detection sensor and a touch operation condition setting unit 25 for sensing a person's touch change or motion to output signals corresponding to four functions of powering on, continuous power supplying, standby power setting, and overload cutoff releasing according to the sensed result; a current detection unit 27 for detecting electric current flowing through the electrical home appliance that is operated under the cooperative operation condition or the single operation condition and outputting a detection signal according to the detection result; a controller for receiving the detection signal and the user's switching signal for selection of a cooperative operation function or a single operation function, outputting an ON or OFF control signal for integratedly controlling a buzzer, a relay, a PIR sensor, a mode switch, an overload breaker, an IR sensor, and an LED, and semipermanently storing a function control value and a standby power value; and an output control unit 26 for receiving the ON or OFF control signal from the controller and controlling the supply or interruption of electric current entering and flowing through a power-saving receptacle of the electric outlet using a relay.

1n addition, the electric outlet driving module 20 can function to transmit the amount of electric current (and electric power) to a control center or other organization using the wired or wireless reception unit through a wired and wireless communication method by grasping the standby power and consumed power of the device plugged into the electric outlet through an current IC and a shunt resistor, and receive an instruction to control the four functions of powering on, continuous power supplying, standby power setting, and overload cutoff releasing through a computer or a smartphone in which the Internet is implemented.

Herein, the wired and wireless communication method can be selected from among a Zigbee communication method, an RF communication method, an IR communication method, and a PIR communication method.

In addition, as shown in FIGS. 6 and 7, the AC three-stage rocker switch 60 is formed in the electric outlet casing 10 and serves to control functions of continuously supplying, saving, and cutting off the power entering the electric outlet through a complete separation from and connection to a power-saving circuit using the bipolar cut-off.

Further, the external receiver connecting port 61 is formed at one side of the AC three-stage rocker switch and serves to allow the amount of electric current of the device plugged into the main power receptacle to be grasped therethrough upon the connection of an automatic and manual switch thereto so as to interrupt or recover the main power receptacle.

The recovery and setting button unit 62 is formed at one side of the AC three-stage rocker switch and serves to selectively convert both recovery and setting functions with one button. In addition, the overload breaker 63 serves to cut off overload when the electric outlet to which the electric plug is connected is overloaded.

As shown in FIG. 8, a controller (MCU) circuit is a circuit that outputs an ON or OFF control signal for integratedly controlling a buzzer, a relay, a PIR sensor, a mode switch, an overload breaker, an IR sensor, and an LED, and semipermanently storing a function control value and a standby power value and controls four functions of powering on, continuous power supplying, standby power setting, and overload cutoff releasing using one switch.

In addition, the external human body detection sensor and a touch operation condition setting unit 28 are disposed separately from the electric outlet driving module 20, and serve to sense a person's touch change or motion to output signals corresponding to four functions of powering on, continuous power supplying, standby power setting, and overload cutoff releasing according to the sensed result.

Further, the touch tact switch 11 includes a function of restoring the operating state of the power-saving receptacle to an electrical conductive state again after the supply of the power to the power-saving receptacle is interrupted when the switch button is pressed once, a function of restoring the operating state of the power-saving receptacle to the power-saving state after the supply of the power to the power-saving receptacle is interrupted automatically within 10 seconds during the supply of electric current ranging from 16A to 19A to the power-saving receptacle when the switch button is pressed twice, a function of releasing the function of a power-saving electric outlet to cause the power-saving receptacle to be converted into a common continuous power receptacle when the button is pressed and released continuously three times within 3 seconds, and a function of storing a current value of the standby power of the device plugged into the power-saving receptacle in a memory of the controller (MCI) through a current IC and an amplification IC within 20 seconds when the button is pressed long for 5 seconds or less, at which time the LED blinds on and off rapidly so that the storage state can be identified with naked eyes and through sounds.

As shown in FIG. 9, a touch switch circuit enables conversion of four functions of powering on, continuous power supplying, standby power setting, and overload cutoff releasing in a module for driving an artificial intelligence type electric outlet according to another embodiment of the present invention.

In addition, as shown in FIG. 10, an IR sensor and LED circuit serves to allow the operations of the electric outlet to be distinguished with naked eyes, and implement the representation of three colors (R, G, O) through a two-color LED.

In addition, the artificial intelligence type electric outlet applies a touch switch employing a touch IC, a tact switch, and an IR wireless reception sensor in a manual method, and applies a human body detection sensor and an object detection sensor for sensing a distance and an object in an automatic method, such that the manual method and the automatic method can be selectively used as an electric power recovery method by means of the function switch.

Further, in a method for representing a function indication of the LED 12, the blinking on and off of a green LED once for 1 second is an indication meaning that the electric outlet is in a standby power state and the power is cut off within 3 minutes, the continuous turning on of the green LED is an indication meaning that the device plugged into the electric outlet is in use, the continuous turning on of a red LED, followed by the turning off of the red LED at a preset time is an indication meaning that the function of the electric outlet is converted from a power-saving function to a common electric outlet function, and the turning off of the LEDs is an indication meaning that the device plugged into the power-saving receptacle is in a powered-off state.

While the present invention has been described in connection with the preferred embodiments illustrated in the drawings and the specification, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical sprit of the appended claims.

### INDUSTRIAL APPLICABILITY

The artificial intelligence type electric outlet having automatic standby power cut-off and recovery functions of the present invention as described above can be selectively applied to a floor-buried electric outlet, a wall-buried electric outlet, a mobile multi-socket outlet, and a power strip, and thus the use and coverage thereof is broadened.

1. An artificial intelligence type electric outlet having automatic standby power cut-off and recovery functions, comprising:
an electric outlet casing including a power receptacle unit having a continuous power receptacle for functioning as a common electric outlet that allows electric plugs of various electronic devices to be plugged thereinto in use, a main power receptacle for dividedly setting the amount of electric current of an electronic device plugged into the main power receptacle to grasp an in-use state, a power-saving state, and a power-off state of the electronic device, and turning ON/OFF an auxiliary power receptacle based on a reference value, and one or more auxiliary power receptacles 50 that is operated in response to a control signal from the main power receptacle, or having the continuous power receptacle 30 and the main power receptacle, the electric outlet casing being configured to maintain the external appearance of a design thereof without the need of forming a hole thereon by inserting a function switch as a touch tact switch and an LED into an injection-molded product without having the touch tact switch 11 and the LED 12 protrudingly formed on a top surface thereof; and
an electric outlet driving module protectively mounted in the electric outlet casing, the electric outlet driving module functioning to implement automatic standby power cut-off and recovery by applying the technology of an object detection sensor, which is a combination of a PIR sensor and an IR sensor, functioning to convert and control four functions of powering on, continuous power supplying, standby power setting, and overload cutoff releasing through the function switch of the electric outlet, and functioning to transmit the amount of electric current (and electric power) to a control center or other organization using the wired or wireless reception unit through a wired and wireless communication method and receive an instruction to control the four functions of powering on, continuous power supplying, standby power setting, and overload cutoff releasing through a computer or a smartphone in which the Internet is implemented.

2. The artificial intelligence type electric outlet according to claim 1, wherein the electric outlet driving module comprises: a power source unit that serves as an SMAP power supply circuit and enable stable circuit operation by converting AC into DC, the power source unit being configured to generate and output an operating voltage to be supplied to respective internal elements of the electric outlet from a power source; an operation condition setting unit for setting whether or not to use the object detection sensor, a human body detection sensor, and the touch tact switch, whether or not to output light from the LED, and a cooperative operation condition or a single operation condition of an electrical home appliance based on a user's switching operation, and outputting a switching signal according to the setting operation; a wireless transmission and reception unit for interconnecting an object detection sensor for sensing a distance and an object and a human body detection sensor using a computer or a smartphone via a wired and wireless communication network so as to determine whether or not the object detection sensor and the human body detection sensor detect the object and the human body; a built-in or external human body detection sensor and a touch operation condition setting unit for sensing a person's touch change or motion to output signals corresponding to four functions of powering on, continuous power supplying, standby power setting, and overload cutoff releasing according to the sensed result; a current detection unit for detecting electric current flowing through the electrical home appliance that is operated under the cooperative operation condition or the single operation condition and outputting a detection signal according to the detection result; a controller for receiving the detection signal and the user's switching signal for selection of a cooperative operation function or a single operation function, outputting an ON or OFF control signal for integratedly controlling a buzzer, a relay, a PIR sensor, a mode switch, an overload breaker, an IR sensor, and an LED, and semipermanently storing a function control value and a standby power value; and an output control unit for receiving the ON or OFF control signal from the controller and controlling the supply or interruption of electric current entering and flowing through a power-saving receptacle of the electric outlet using a relay.

3. The artificial intelligence type electric outlet according to claim 1, further comprising an three-stage AC rocker switch formed in the electric outlet casing for controlling functions of continuously supplying, saving, and cutting off the power entering the electric outlet through a complete separation from and connection to a power-saving circuit using the bipolar cut-off.

4. The artificial intelligence type electric outlet according to claim 3, further comprising:
an external receiver connecting port formed at one side of the AC three-stage rocker switch and configured to allow the amount of electric current of the device plugged into the main power receptacle to be grasped therethrough upon the connection of an automatic and manual switch thereto so as to interrupt or recover the main power receptacle; and
a recovery and setting button unit formed at one side of the AC three-stage rocker switch and configured to selectively convert both recovery and setting functions with one button.

5. The artificial intelligence type electric outlet according to claim 1, further comprising an overload breaker configured to cut off overload when the electric outlet to which the electric plug is connected is overloaded.

6. The artificial intelligence type electric outlet according to claim 1, wherein the function switch as the touch tact switch comprises a function of restoring the operating state of the power-saving receptacle to an electrical conductive state again after the supply of the power to the power-saving receptacle is interrupted when the switch button is pressed once, a function of restoring the operating state of the power-saving receptacle to the power-saving state after the supply of the power to the power-saving receptacle is interrupted automatically within 10 seconds during the supply of electric current ranging from 16A to 19A to the power-saving receptacle when the switch button is pressed twice, a function of releasing the function of a power-saving electric outlet to cause the power-saving receptacle to be converted into a common continuous power receptacle when the button is pressed and released continuously three times within 3 seconds, and a function of storing a current value of the standby power of the device plugged into the power-saving receptacle in a memory of the controller (MCI) through a current IC and an amplification IC within 20 seconds when the button is pressed long for 5 seconds or less, at which time the LED blinds on and off rapidly so that the storage state can be identified with naked eyes and through sounds generated from a buzzer, and wherein in a method for representing a function indication of the LED 12, the blinking on and off of a green LED once for 1 second is an indication meaning that the electric outlet is in a standby power state and the power is cut off within 3 minutes, the continuous turning on of the green LED is an indication meaning that the device plugged into the electric outlet is in use, the continuous turning on of a red LED, followed by the turning off of the red LED at a preset time is an indication meaning that the function of the electric outlet is converted from a power-saving function to a common electric outlet function, and the turning off of the LEDs is an indication meaning that the device plugged into the power-saving receptacle is in a powered-off state.

7. The artificial intelligence type electric outlet according to claim 1, wherein the electric outlet driving module functions to transmit the amount of electric current (and electric power) to a control center or other organization using the wired or wireless reception unit through a wired and wireless communication method by grasping the standby power and consumed power of the device plugged into the electric outlet through an current IC and a shunt resistor, and receive an instruction to control the four functions of powering on, continuous power supplying, standby power setting, and overload cutoff releasing through a computer or a smartphone in which the Internet is implemented.

8. The artificial intelligence type electric outlet according to claim 1, wherein the artificial intelligence type electric outlet applies a touch switch employing a touch IC, a tact switch, and an IR wireless reception sensor in a manual method, and applies a human body detection sensor and an object detection sensor for sensing a distance and an object in an automatic method, such that the manual method and the automatic method can be selectively used as an electric power recovery method by means of the function switch.

9. The artificial intelligence type electric outlet according to claim 1, wherein the artificial intelligence type electric outlet having automatic standby power cut-off and recovery functions sets and inputs the powering on- and off-time of the electric outlet using an application of a smartphone or a personal computer through a radio communication selected from Bluetooth, Zigbee communication, RF communication, and then act as a timer automatically.

10. The artificial intelligence type electric outlet according to claim 1, wherein the artificial intelligence type electric outlet having automatic standby power cut-off and recovery functions is selectively applied to a floor-buried electric outlet, a wall-buried electric outlet, a mobile multi-socket outlet, and a power strip.
